(19) United States
(12) Patent Application Publication
(10) Pub. No.: US 2007/0246111 A1
(43) Pub. Date: Oct. 25, 2007

(54) Actuating valve with control port vent to ameliorate supply pressure fluctuation

(76) Inventors: Santos Burrola, Juarez (MX); Alejandro Moreno, El Paso, TX (US)

Correspondence Address: DELPHI TECHNOLOGIES, INC., M/C 480-410-202, PO BOX 5052, TROY, MI, 48007, US

(21) Appl. No.: 11/406,623

(22) Filed: Apr. 19, 2006

(51) Int. Cl. F16K 31/06

(52) U.S. Cl. 137/625.65; 137/625.68

(57) ABSTRACT

A spool valve for, e.g., a vehicle automatic transmission system include a valve body defining an exhaust port, a supply port, and a control port. A solenoid-actuated spool is disposed in the valve body and reciprocates between a closed configuration, wherein the supply port is fluidly isolated from the control port, and an open configuration, where fluid communication is established between the supply port and control port. The spool is juxtaposed with a chamber formed by a closed end of the valve body. A bleed passageway is formed in the spool from the chamber to an exit port that is juxtaposed with the exhaust port. The end piston on the spool nearest the chamber allows fluid in an intermediate configuration to communicate from the control port to the chamber, from the chamber through the bleed passageway, and out of the exhaust port to ameliorate the effect of fluctuations in fluid supplied to the valve.

### FIELD OF THE INVENTION

The present invention relates generally to valves for vehicle hydraulic systems such as automatic transmission systems.

### BACKGROUND OF THE INVENTION

Modern vehicles have many control systems in which a controller, in response to sensor signals, actuates vehicle components to control the vehicle. As one illustration, an engine control module (ECM) might receive input from various sensors and in response turn “on” and “off” actuation coils of various hydraulic valves to cause an automatic transmission to shift.

Spool valves are one type of valve that can be used for hydraulic control purposes. The valves in essence control the flow or pressure of the hydraulic fluid through various fluid chambers by causing a spool to slide within a valve housing, opening and closing various ports in the housing as it does so. Typically, the ports include a supply port that is connected to a hydraulic fluid supply, an exhaust port that exhausts fluid back to the hydraulic fluid supply, and a control port that is connected to the component sought to be controlled, e.g., to a transmission component.

In some applications it is desirable that the control flow or pressure which is output from the valve be proportional to the input electrical signal provided to the actuating solenoid. As critically recognized herein, fluctuations in supply fluid pressure (as can happen due to supply fluid pump vagaries) can reduce the performance of the valve. With this critical recognition in mind, the invention herein is provided.

### SUMMARY OF THE INVENTION

A valve has a valve body defining an exhaust port, a supply port, and a control port. A spool is disposed in the valve body and reciprocates therein between a closed configuration, wherein the supply port is fluidly isolated from the control port, and an open configuration, where fluid communication is established between the supply port and control port. An end piston of the spool is juxtaposed with a chamber formed by a closed end of the valve body. A bleed passageway is formed in the spool from the chamber to an exit port juxtaposed with the exhaust port, and structure is provided on the spool to allow fluid, in at least one configuration intermediate the open and closed configurations, to communicate from the control port to the chamber, with the fluid also being permitted to flow from the chamber through the bleed passageway and out of the exhaust port to ameliorate the effect of fluctuations in fluid supplied to the valve. Fluid is not permitted to flow from the control port to the chamber in the open configuration.

The structure may include a radial step formed on the end piston of the spool. The radial step is not in the control port in the open configuration but it is in the control port in the intermediate configuration. Alternatively, the structure may include at least one axially-oriented groove formed in the outer wall of the end piston and extending from a chamber face toward, but not reaching, a control port face. Fluid cannot flow past the end piston in the open configuration but fluid can flow through the groove into the chamber in the intermediate configuration. In still another implementation the structure includes a control passageway having a control entry port blocked by the valve body in the open configuration and not blocked in the intermediate configuration.

In another aspect, a valve has a valve body defining an exhaust port, a supply port, and a control port. A spool is disposed in the valve body and reciprocates therein between a closed configuration, wherein the supply port is fluidly isolated from the control port, and an open configuration, where fluid communication is established between the supply port and control port. An end piston of the spool is juxtaposed with a chamber formed by a closed end of the valve body. A bleed passageway is formed in the spool from the chamber to an exit port juxtaposed with the exhaust port. The end piston allows fluid, in at least one configuration intermediate the open and closed configurations, to communicate from the control port to the chamber, with the fluid also being permitted to flow from the chamber through the bleed passageway and out of the exhaust port to ameliorate the effect of fluctuations in fluid supplied to the valve. Fluid is not permitted to flow from the control port to the chamber in the open configuration.

In another aspect, a valve has a valve body defining an exhaust port, a supply port, and a control port. A spool is disposed in the valve body and reciprocates therein between a closed configuration, wherein the supply port is fluidly isolated from the control port, and an open configuration, where fluid communication is established between the supply port and control port. An end piston of the spool is juxtaposed with a chamber formed by a closed end of the valve body. A bleed passageway is formed in the spool from the chamber to an exit port juxtaposed with the exhaust port. Means are provided for allowing fluid, in at least one configuration intermediate the open and closed configurations, to communicate from the control port to the chamber, the means for allowing fluid also permitting fluid to flow from the chamber through the bleed passageway and out of the exhaust port in the configuration intermediate the open and closed configurations to ameliorate the effect of fluctuations in fluid supplied to the valve.

The details of the present invention, both as to its structure and operation, can best be understood in reference to the accompanying drawings, in which like reference numerals refer to like parts, and in which:

### BRIEF DESCRIPTION OF THE DRAWINGS

FIG. 1 is a block diagram showing the present valve in one non-limiting environment;

FIG. 2 is a cross-section of the valve in the closed configuration when the actuating solenoid is deenergized;

FIG. 3 is a cross-section of the valve midway between the closed configuration and open configuration just after the actuating solenoid has been energized;

FIG. 4 is a cross-section of the valve in the open configuration when the actuating solenoid is energized;

FIG. 5 is an isometric view of an alternate spool;

FIG. 6 is a cross-sectional view of another alternate spool in the open configuration; and

FIG. 7 is a cross-sectional view of the alternate spool shown in FIG. 6, but in the intermediate configuration.

### DETAILED DESCRIPTION OF THE PREFERRED EMBODIMENT

The present invention is intended for application in automotive vehicle transmission systems and will be described in that context. It is to be understood, however, that the present invention could also be successfully applied in many other applications. Other applications include but are not limited to vehicle heavy equipment applications, engine cam phasing, etc.

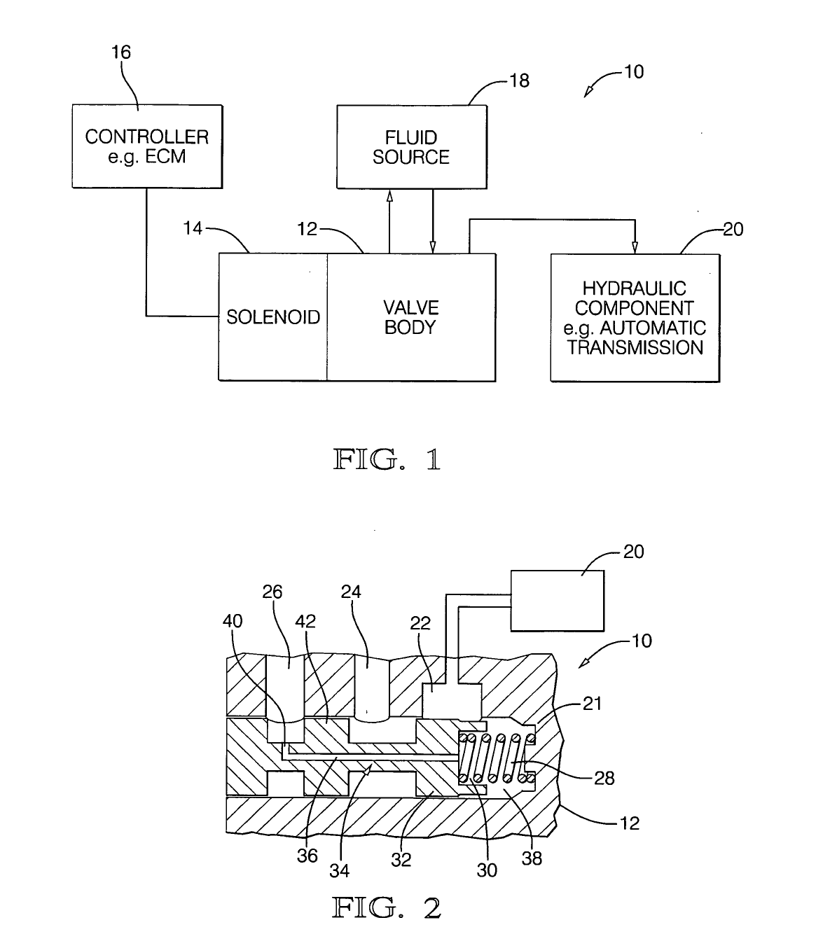

Referring initially to FIG. 1, a valve 10 is shown that includes a rigid valve body 12 and an actuating solenoid 14. The solenoid 14 can be energized and deenergized under the control of a controller 16 such as an engine control module (ECM) to move below-described components within the valve body 12 to selectively port hydraulic fluid from a fluid source 18 to and from a hydraulic component 20, such as a vehicle automatic transmission.

FIGS. 2-4 show that the valve body 12 has a closed end 21 and, formed in sequence from the closed end 21 in a line, a control port 22 that is connected to the component 20 sought to be controlled, a supply port 24, and an exhaust port 26, with the supply and exhaust ports 24, 26 being connected to the fluid source 18 shown in FIG. 1. A return spring 28 can be disposed as shown against the closed end 21 and against a spring receptacle 30 of a piston 32 of a spool 34. The spool 34 is disposed in the valve body 12 and is movable therein under the influence of the actuating solenoid 14, which can be energized in accordance with principles known in the art to cause the spool 34 to move to the right looking down in FIGS. 2-4 and compress the return spring 28. In the embodiment shown in FIGS. 2-4, the spool 34 is formed with a small bleed passageway 36 that extends from the chamber 38 in which the return spring 28 is disposed to an exit port 40 that is juxtaposed with the exhaust port 26 when the solenoid is deenergized, for purposes to be shortly disclosed.

In the closed configuration shown in FIG. 2, the solenoid is deenergized, and the return spring 28 has urged the spool left looking down on FIGS. 2-4 such that an intermediate spool piston 42 isolates the exhaust port 26 from the supply port 24. Also, the end piston 32 isolates the supply port 24 from the control port 22 as shown. In the open configuration shown in FIG. 4, in contrast, a free end piston 46 blocks the exhaust port 26, but fluid communication is established between the supply and control ports 24, 22 as shown by the arrows 48. Also, as shown in FIG. 4, when the valve 10 is in the open configuration an enlarged portion 50 of the end piston 32 blocks fluid flow between the control port 22 and the chamber 38.

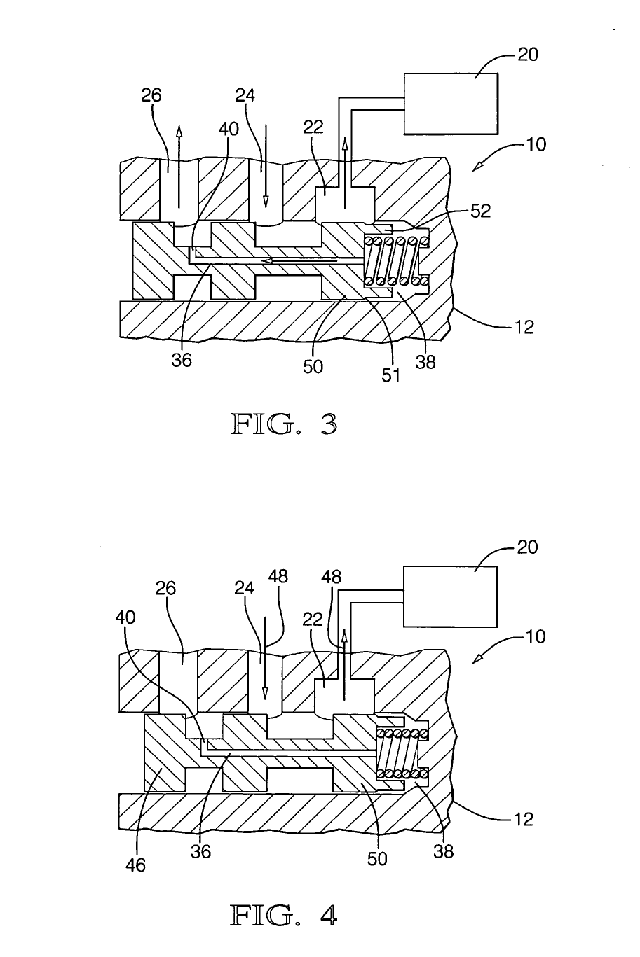

In contrast, as the valve 10 is moving between the open and closed configurations, an intermediate situation shown in FIG. 3 results in which fluid can flow from the control port 22 into the chamber 38, owing to a radial step 51 that is formed between the enlarged portion 50 of the end piston 32 and a smaller diameter portion 52 of the end piston 32. In the configuration shown in FIG. 3, the radial step is in the control port so that fluid is able to bleed between the smaller diameter portion 52 and the inside diameter of the valve body into the chamber 38. In turn, fluid can flow from the chamber 38 through the bleed passageway 36 of the spool 34, out of the exit port 40 and through the exhaust port 26 as shown. However, the radial step 51 is not in the control port in the open configuration shown in FIG. 4, thus preventing fluid to flow from the control port to the chamber.

The combination of restricted fluid flow in the intermediate configuration between the supply port 24 and control port 22, between the control port 22 and the chamber 38, and between the chamber 38 and exit port 40 ameliorates the effect of fluctuations in fluid supplied through the supply port 24. The fluid flow in the intermediate configuration shown in FIG. 3 is indicated by the arrows.

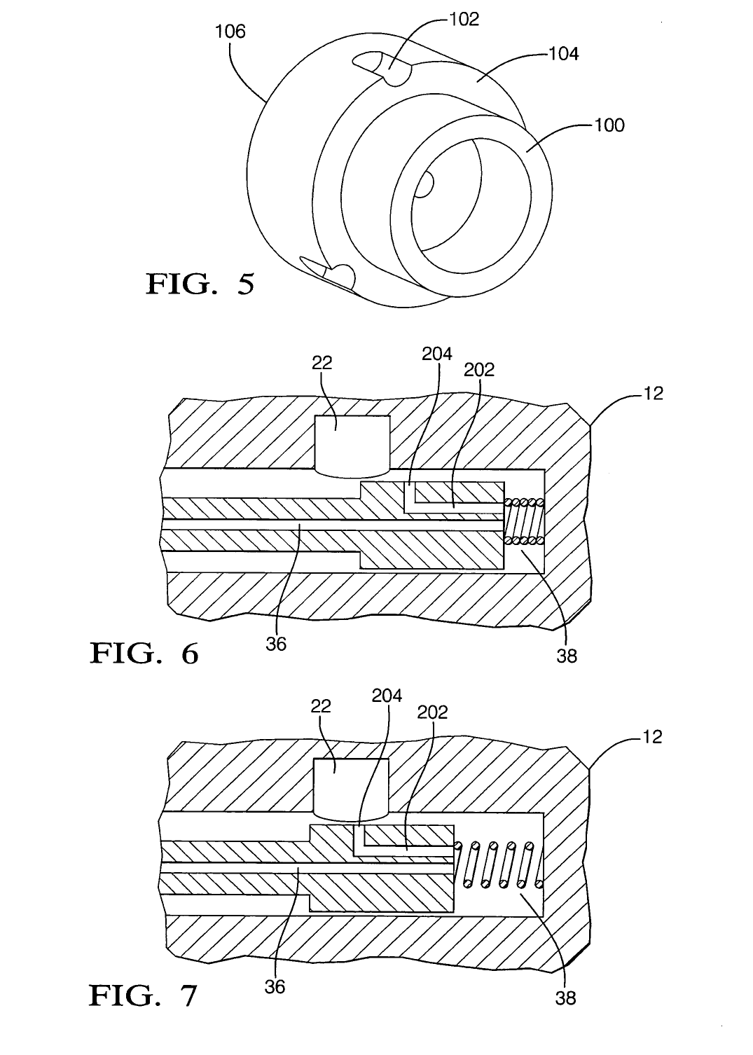

Instead of or in addition to the radial step 51 in the end piston 32, FIG. 5 shows an alternate spool piston 100 that is formed with plural axially-oriented grooves 102, with each groove formed in the outer wall of the end piston 100 as shown and extending from a chamber face 104 that is disposed in the chamber 38. The grooves 102 extend part way toward, but do not reach, a control port face 106 of the end piston 100. The control port face is juxtaposed with the control port as shown. In this way, fluid cannot flow past the end piston 100 in the fully open configuration but it can flow through the grooves 102 into the chamber 38 once the spool has moved to the intermediate configuration.

FIGS. 6 and 7 show yet another structure for allowing fluid in the intermediate valve configuration to communicate from the control port 22 to the chamber 38. An end piston 200 can be formed as in prior embodiments with a bleed passageway 36 extending from the chamber 38 to the exhaust port, and the end piston 200 is also formed with an L-shaped control passageway 202. In the open configuration shown in FIG. 6 a control entry port 204 of the control passageway 202 is blocked by the valve body 12, whereas in the intermediate configuration shown in FIG. 7 the control entry port 204 of the control passageway 202 is not blocked, allowing fluid to flow from the control port 22 into the chamber 38.

While the particular VALVE WITH CONTROL PORT VENT TO AMELIORATE SUPPLY PRESSURE FLUCTUATION as herein shown and described in detail is fully capable of attaining the above-described objects of the invention, it is to be understood that it is the presently preferred embodiment of the present invention and is thus representative of the subject matter which is broadly contemplated by the present invention, and that the scope of the present invention is accordingly to be limited by nothing other than the appended claims, in which reference to an element in the singular is not intended to mean “one and only one” unless explicitly so stated, but rather “one or more”. It is not necessary for a device or method to address each and every problem sought to be solved by the present invention, for it to be encompassed by the present claims. Furthermore, no element, component, or method step in the present disclosure is intended to be dedicated to the public regardless of whether the element, component, or method step is explicitly recited in the claims.

What is claimed is:

1. A valve, comprising:
a valve body defining an exhaust port, a supply port, and a control port;
a spool at least partially disposed in the valve body and reciprocally movable therein between a closed configuration, wherein the supply port is fluidly isolated from the control port, and an open configuration, where fluid communication is established between the supply port and control port, the spool being juxtaposed with a chamber formed by a closed end of the valve body;
an actuating solenoid energizable to cause the spool to move;
a bleed passageway formed in the spool from the chamber to an exit port juxtaposed with the exhaust port; and
structure on the spool allowing fluid, in at least one configuration intermediate the open and closed configurations, to communicate from the control port to the chamber, fluid also being permitted to flow from the chamber through the bleed passageway and out of the exhaust port in the configuration intermediate the open and closed configurations to ameliorate the effect of fluctuations in fluid supplied to the valve, fluid not being permitted to flow from the control port to the chamber at least in the open configuration.

2. The valve of claim 1, wherein the structure includes a radial step formed on an end piston of the spool, the radial step not being in the control port in the open configuration and being in the control port in the configuration intermediate the open and closed configurations.

3. The valve of claim 1, wherein the structure includes at least one axially-oriented groove formed in an outer wall of an end piston of the spool and extending from a first face of the end piston toward, but not reaching, an opposed second face, the first face facing the chamber and the second face facing the control port, whereby fluid cannot flow past the end piston in the open configuration but fluid can flow through the groove into the chamber in the configuration intermediate the open and closed configurations.

4. The valve of claim 1, wherein the structure includes at least one control passageway having a control entry port blocked by the valve body in the open configuration, the control entry port of the control passageway not being blocked in the configuration intermediate the open and closed configurations such that fluid can flow from the control port, through the control passageway, and into the chamber.

5. The valve of claim 4, wherein the control passageway is L-shaped.

6. The valve of claim 1, wherein the control port is in fluid communication with a hydraulic component of a vehicle.

7. The valve of claim 6, wherein the hydraulic component is a portion of an automatic transmission.

8. A valve, comprising:
a valve body defining an exhaust port, a supply port, and a control port;
a spool at least partially disposed in the valve body and reciprocally movable therein between a closed configuration, wherein the supply port is fluidly isolated from the control port, and an open configuration, where fluid communication is established between the supply port and control port, the spool being juxtaposed with a chamber formed by a closed end of the valve body;
an actuating solenoid energizable to cause the spool to move;
a bleed passageway formed in the spool from the chamber to an exit port juxtaposed with the exhaust port; and
an end piston on the spool allowing fluid, in at least one configuration intermediate the open and closed configurations, to communicate from the control port to the chamber, the end piston also permitting fluid to flow from the chamber through the bleed passageway and out of the exhaust port in the configuration intermediate the open and closed configurations to ameliorate the effect of fluctuations in fluid supplied to the valve, the end piston not permitting fluid to flow from the control port to the chamber at least in the open configuration.

9. The valve of claim 8, wherein the end piston includes a radial step not being in the control port in the open configuration and being in the control port in the configuration intermediate the open and closed configurations.

10. The valve of claim 8, wherein the end piston includes at least one axially-oriented groove formed in an outer wall of the end piston and extending from a first face of the end piston toward, but not reaching, an opposed second face, the first face facing the chamber and the second face facing the control port, whereby fluid cannot flow past the end piston in the open configuration but fluid can flow through the groove into the chamber in the configuration intermediate the open and closed configurations.

11. The valve of claim 8, wherein the end piston includes at least one control passageway having a control entry port blocked by the valve body in the open configuration, the control entry port of the control passageway not being blocked in the configuration intermediate the open and closed configurations such that fluid can flow from the control port, through the control passageway, and into the chamber.

12. The valve of claim 11, wherein the control passageway is L-shaped.

13. The valve of claim 8, wherein the control port is in fluid communication with a hydraulic component of a vehicle.

14. The valve of claim 13, wherein the hydraulic component is a portion of an automatic transmission.

15. A valve, comprising:
a valve body defining an exhaust port, a supply port, and a control port;
a spool at least partially disposed in the valve body and reciprocally movable therein between a closed configuration, wherein the supply port is fluidly isolated from the control port, and an open configuration, where fluid communication is established between the supply port and control port, the spool being juxtaposed with a chamber formed by a closed end of the valve body;
an actuating solenoid energizable to cause the spool to move;
a bleed passageway formed in the spool from the chamber to an exit port juxtaposed with the exhaust port; and
means for allowing fluid, in at least one configuration intermediate the open and closed configurations, to communicate from the control port to the chamber, the means for allowing fluid also permitting fluid to flow from the chamber through the bleed passageway and out of the exhaust port in the configuration intermediate the open and closed configurations to ameliorate the effect of fluctuations in fluid supplied to the valve, fluid not being permitted to flow from the control port to the chamber at least in the open configuration.

16. The valve of claim 15, wherein the means for allowing is an end piston including a radial step not being in the control port in the open configuration and being in the control port in the configuration intermediate the open and closed configurations.

17. The valve of claim 15, wherein the means for allowing fluid is an end piston including at least one axially-oriented groove formed in an outer wall of the end piston and extending from a first face of the end piston toward, but not reaching, an opposed second face, the first face facing the chamber and the second face facing the control port, whereby fluid cannot flow past the end piston in the open configuration but fluid can flow through the groove into the chamber in the configuration intermediate the open and closed configurations

18. The valve of claim 15, wherein the means for allowing fluid is an end piston including at least one control passageway having a control entry port blocked by the valve body in the open configuration, the control entry port of the control passageway not being blocked in the configuration intermediate the open and closed configurations such that fluid can flow from the control port, through the control passageway, and into the chamber.

19. The valve of claim 15, wherein the control port is in fluid communication with a hydraulic component of a vehicle.

20. The valve of claim 19, wherein the hydraulic component is a portion of an automatic transmission.
